(19) United States
(12) Patent Application Publication
(10) Pub. No.: US 2026/0203115 A1
(43) Pub. Date: Jul. 16, 2026

(54) LCS RESOURCE UTILIZATION TRACKING SYSTEM

(71) Applicant: Dell Products L.P., Round Rock, TX (US)

(72) Inventors: Douglas Lang Farley, Round Rock, TX (US); Srinivas Giri Raju Gowda, Fremont, CA (US); William Price Dawkins, Lakeway, TX (US); Trevor Christian Cockrell, Hutto, TX (US)

(21) Appl. No.: 19/018,296

(22) Filed: Jan. 13, 2025

(51) Int. Cl. G06F 9/50

(52) U.S. Cl. CPC G06F 9/5027

(57) ABSTRACT

An LCS resource utilization tracking system includes resource devices, a resource management system that composes first and second LCSs using a first resource device, and an LCS resource utilization tracking subsystem coupled to the resource devices and the resource management system. The LCS resource utilization tracking subsystem receives a first request for the first LCS to utilize the first resource device and, in response, enables and tracks the utilization of the first resource device by the first LCS and identifies first utilization billing information based on that tracked utilization to the resource management system. The LCS resource utilization tracking subsystem receives a second request for the second LCS to utilize the first resource device and, in response, enables and tracks the utilization of the first resource device by the second LCS and identifies second utilization billing information based on that tracked utilization of to the resource management system.

### CROSS-REFERENCE TO RELATED APPLICATION

The present application is related to co-pending U.S. patent application Ser. No. ______, attorney docket no. 141530.01, filed ______, the disclosure of which is incorporated by reference herein in its entirety.

### BACKGROUND

The present disclosure relates generally to information handling systems, and more particularly to tracking resource utilization by Logically Composed Systems (LCSs) provided by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

While conventional information handling systems such as, for example, server devices and/or other computing devices known in the art have traditionally been provided with particular information handling systems components that configure them to satisfy one or more use cases, new computing paradigms provide for the allocation of resources from information handling systems and/or information handling system components for use in Logically Composed Systems (LCSs) that may be composed as needed to satisfy any computing intent/workload, and then decomposed such that those resources may be utilized in other LCSs. As such, users of the LCSs may be provided with LCSs that meet their current needs for any particular workload they require.

For example, an LCS may be provided using a Bare Metal Servers (BMS), with processing resources and memory resources in the BMS used to provide an Operating System (OS) for the LCS, and with different resources that may be included in the BMS and/or that are connected to the BMS via a network used to provide any desired functionality for the LCS. As such, LCSs may be composed of disaggregated, heterogeneous resources that may be used to perform operations for that LCS, or for “nested” LCSs that may be provided using that LCS. The inventors of the present disclosure have recognized that it would be beneficial to monitor and report granular details of the use of resources by different LCSs for future resource scheduling purposes, billing purposes, and/or other LCS-related purposes known in the art. However, while in conventional LCS provisioning systems the identity of particular resources that are used to provide an LCS may be known, the details of the use of those resources by any LCS remain unknown, particularly with regard to the “nested” LCSs discussed above whose utilization of resources is indistinguishable from the utilization of those resources by the LCS that is providing that “nested” LCS.

Accordingly, it would be desirable to provide an LCS resource utilization tracking system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a Logically Composed System (LCS) resource utilization tracking engine that is configured to: receive a first LCS utilization request for a first LCS to utilize a first resource device; enable and track, in response to the first LCS utilization request, the utilization of the first resource device by the first LCS; identify, to a resource management system based on the tracking of the utilization of the first resource device by the first LCS, first utilization billing information for the utilization of the first resource device by the first LCS; receive a second LCS utilization request for the second LCS to utilize the first resource device; enable and track, in response to the second LCS utilization request, the utilization of the first resource device by the second LCS; and identify, to the resource management system based on the tracking of the utilization of the first resource device by the second LCS, second utilization billing information for the utilization of the first resource device by the second LCS.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a flow chart illustrating an embodiment of a method for tracking the utilization of resources by an LCS.

FIG. 8 is a schematic view illustrating an embodiment of an LCS provisioning subsystem that may be provided by the LCS provisioning subsystem of FIG. 3.

FIG. 9A is a schematic view illustrating an embodiment of the LCS provisioning subsystem of FIG. 8 operating during the method of FIG. 7.

FIG. 9B is a schematic view illustrating an embodiment of the LCS provisioning subsystem of FIG. 8 operating during the method of FIG. 7.

FIG. 10 is a schematic view illustrating an embodiment of the LCS provisioning subsystem of FIG. 8 operating during the method of FIG. 7.

FIG. 11A is a schematic view illustrating an embodiment of the LCS provisioning subsystem of FIG. 8 operating during the method of FIG. 7.

FIG. 11B is a schematic view illustrating an embodiment of the LCS provisioning subsystem of FIG. 8 operating during the method of FIG. 7.

FIG. 12 is a schematic view illustrating an embodiment of the LCS provisioning subsystem of FIG. 8 operating during the method of FIG. 7.

FIG. 13A is a schematic view illustrating an embodiment of the LCS provisioning subsystem of FIG. 8 operating during the method of FIG. 7.

FIG. 13B is a schematic view illustrating an embodiment of the LCS provisioning subsystem of FIG. 8 operating during the method of FIG. 7.

FIG. 14A is a schematic view illustrating an embodiment of the LCS provisioning subsystem of FIG. 8 operating during the method of FIG. 7.

FIG. 14B is a schematic view illustrating an embodiment of the LCS provisioning subsystem of FIG. 8 operating during the method of FIG. 7.

FIG. 14C is a schematic view illustrating an embodiment of the LCS provisioning subsystem of FIG. 8 operating during the method of FIG. 7.

FIG. 15A is a schematic view illustrating an embodiment of the LCS provisioning subsystem of FIG. 8 operating during the method of FIG. 7.

FIG. 15B is a schematic view illustrating an embodiment of the LCS provisioning subsystem of FIG. 8 operating during the method of FIG. 7.

FIG. 16 is a schematic view illustrating an embodiment of the LCS provisioning subsystem of FIG. 8 operating during the method of FIG. 7.

FIG. 17 is a schematic view illustrating an embodiment of the LCS provisioning subsystem of FIG. 8 operating during the method of FIG. 7.

FIG. 18 is a schematic view illustrating an embodiment of the LCS provisioning subsystem of FIG. 8 operating during the method of FIG. 7.

FIG. 19A is a schematic view illustrating an embodiment of the LCS provisioning subsystem of FIG. 8 operating during the method of FIG. 7.

FIG. 19B is a schematic view illustrating an embodiment of the LCS provisioning subsystem of FIG. 8 operating during the method of FIG. 7.

FIG. 20A is a schematic view illustrating an embodiment of the LCS provisioning subsystem of FIG. 8 operating during the method of FIG. 7.

FIG. 20B is a schematic view illustrating an embodiment of the LCS provisioning subsystem of FIG. 8 operating during the method of FIG. 7.

FIG. 20C is a schematic view illustrating an embodiment of the LCS provisioning subsystem of FIG. 8 operating during the method of FIG. 7.

FIG. 21A is a schematic view illustrating an embodiment of the LCS provisioning subsystem of FIG. 8 operating during the method of FIG. 7.

FIG. 21B is a schematic view illustrating an embodiment of the LCS provisioning subsystem of FIG. 8 operating during the method of FIG. 7.

FIG. 22 is a schematic view illustrating an embodiment of the LCS provisioning subsystem of FIG. 8 operating during the method of FIG. 7.

FIG. 23 is a schematic view illustrating an embodiment of the LCS provisioning subsystem of FIG. 8 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

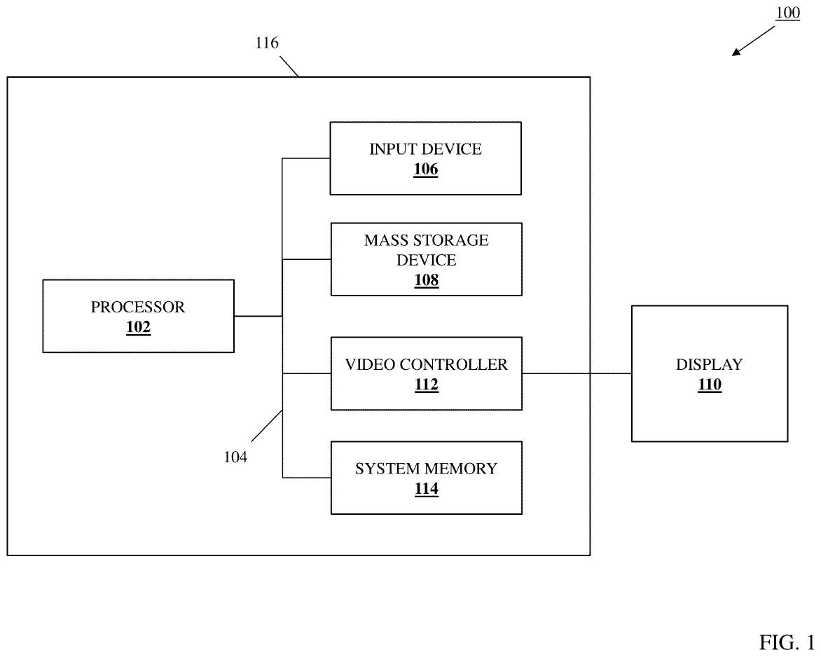

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the Logically Composed System (LCS) resource utilization tracking systems and methods of the present disclosure may be utilized with LCSs, which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

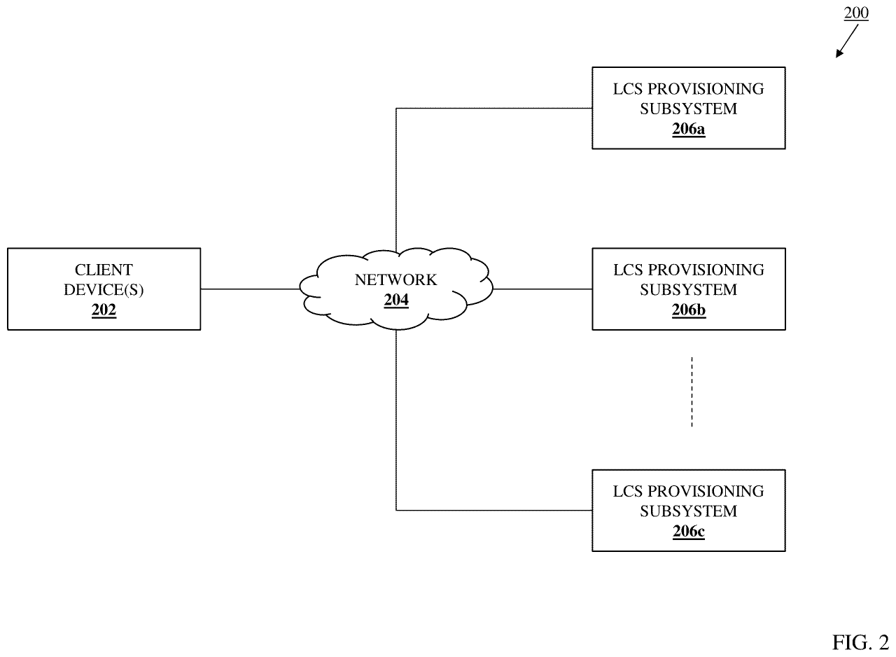

With reference to FIG. 2, an embodiment of a Logically Composed System (LCS) provisioning system 200 is illustrated that may be utilized with the LCS resource utilization and tracking systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

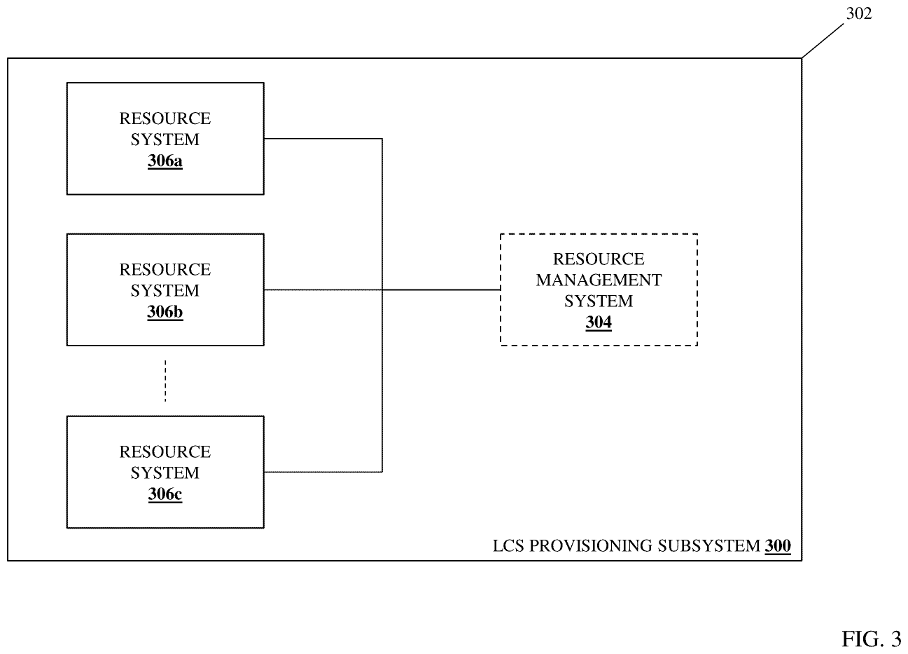

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

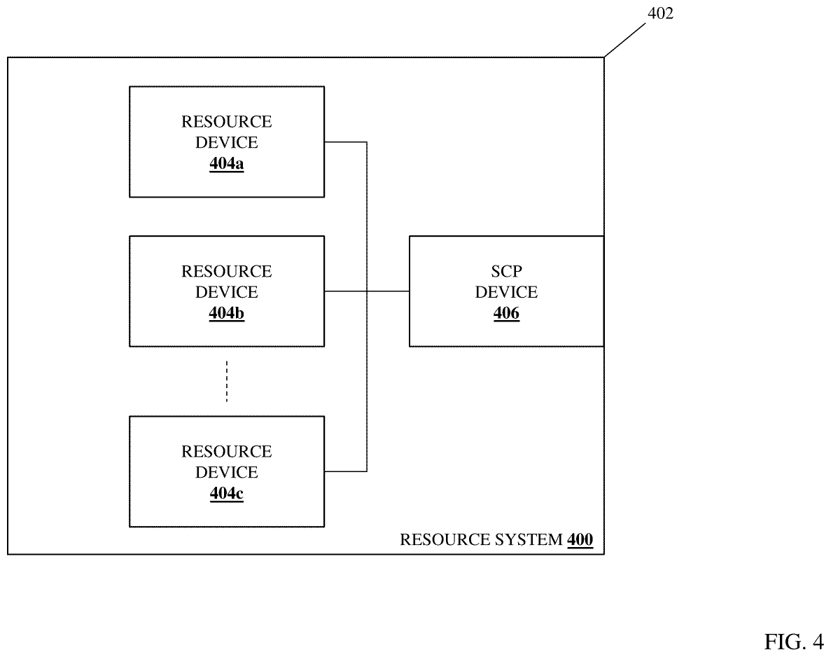

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciated that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

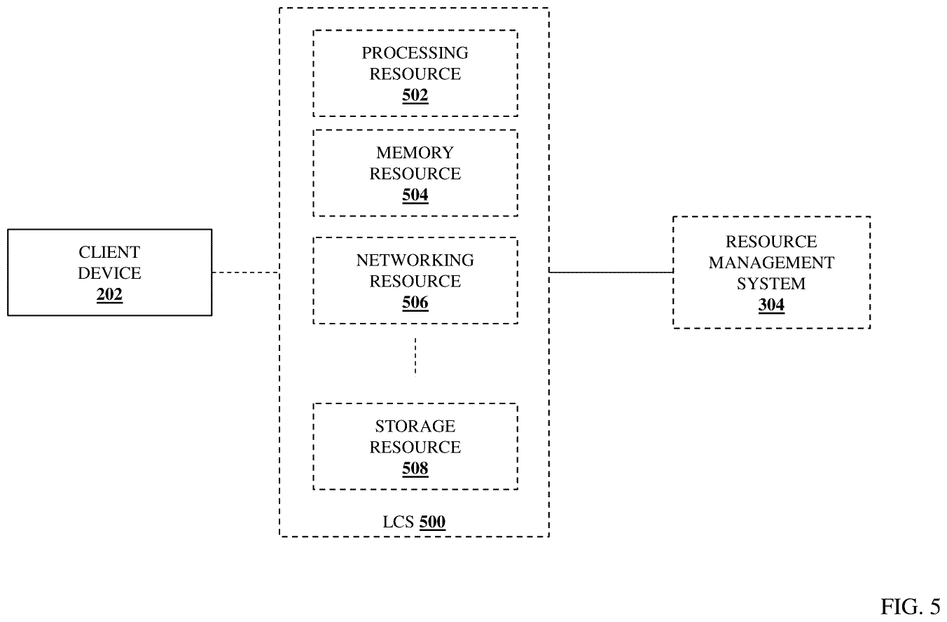

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

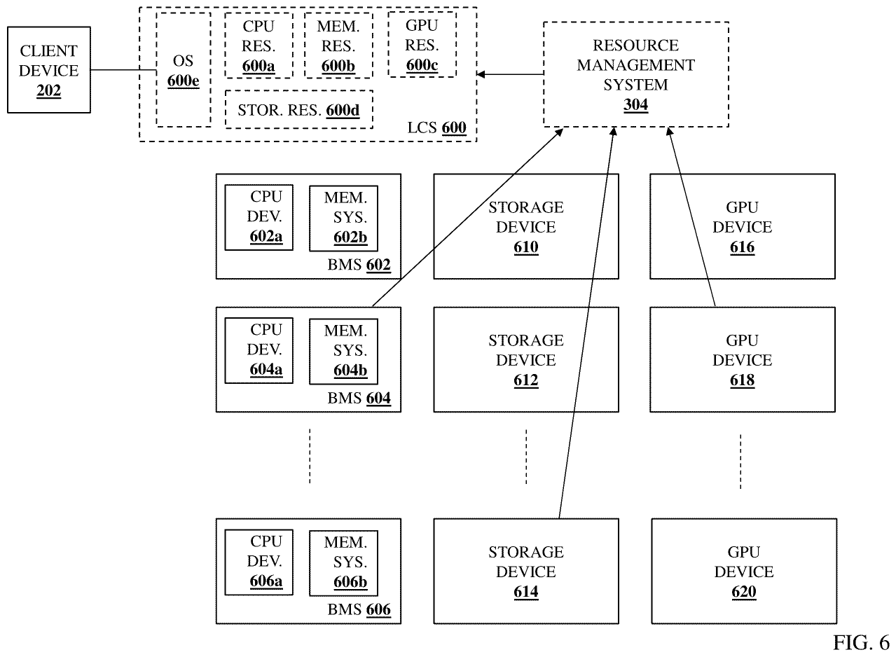

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

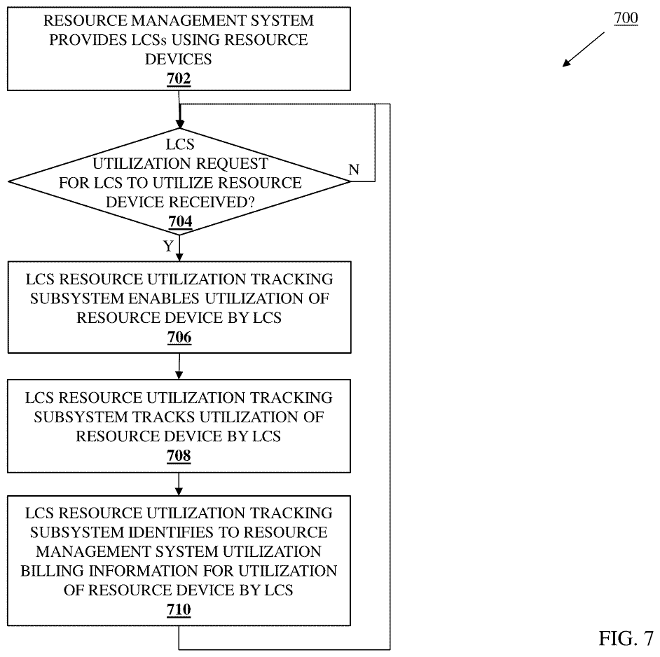

Referring now to FIG. 7, an embodiment of a method 700 for tracking the utilization of resources by a Logically Composed System (LCS) is illustrated. As discussed below, the systems and methods of the present disclosure provide for the tracking of the utilizations of a resource device by different LCSs in order to allow respective billing utilization information for each of those utilizations to be identified. For example, the LCS resource utilization tracking system of the present disclosure may include resource devices, a resource management system that composes first and second LCSs using a first resource device, and an LCS resource utilization tracking subsystem coupled to the resource devices and the resource management system. The LCS resource utilization tracking subsystem receives a first request for the first LCS to utilize the first resource device and, in response, enables and tracks the utilization of the first resource device by the first LCS and identifies first utilization billing information based on that tracked utilization to the resource management system. The LCS resource utilization tracking subsystem receives a second request for the second LCS to utilize the first resource device and, in response, enables and tracks the utilization of the first resource device by the second LCS and identifies second utilization billing information based on that tracked utilization of to the resource management system. As such, the details of the use of resource devices by any LCS may be identified, particularly with regard to “nested” LCSs whose utilization of resource devices is conventionally indistinguishable from the utilization of those resource devices by the LCS that provide them.

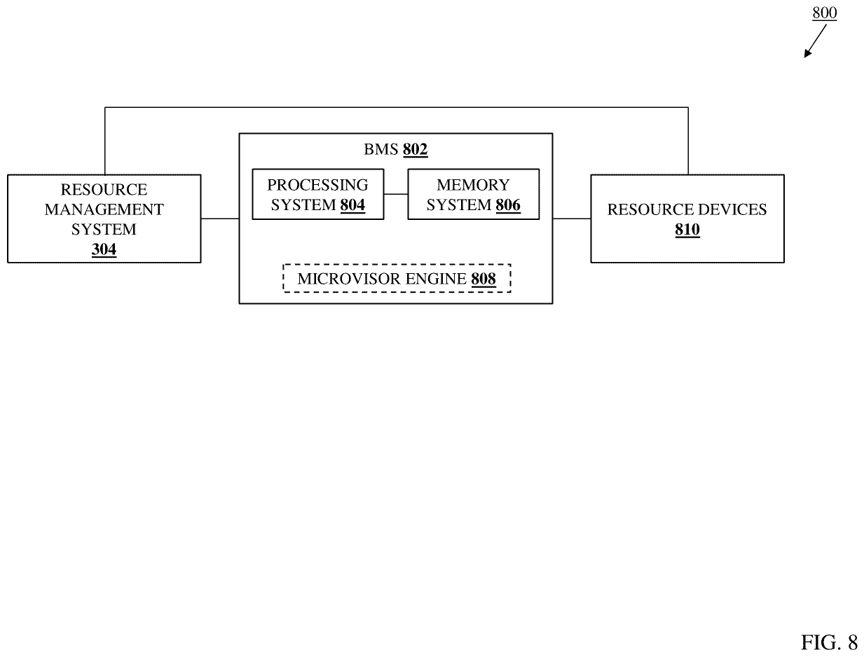

The method 700 begins at block 702 where a resource management system provides LCSs using resource devices. With reference to FIG. 8, an embodiment of an LCS provisioning subsystem 800 is illustrated that may be provided by the LCS provisioning subsystem 300 discussed above with reference to FIG. 3, with any of the resource systems 306a-306c provided by the resource system 400 discussed above with reference to FIG. 4. For example, the LCS provisioning subsystem 800 includes the resource management system 304 discussed above with reference to FIG. 3. As illustrated, a Bare Metal Server (BMS) 802 may be coupled to the resource management system 304, and may be provided by any of the BMSs 602-606 discussed above with reference to FIG. 6. As illustrated, the BMS 802 may include a processing system 804 (e.g., the processor 102 discussed above with reference to FIG. 1 such as, for example, a Central Processing Unit (CPU)) and a memory system 806 (e.g., the memory 114 discussed above with reference to FIG. 1 such as, for example, Dynamic Random Access Memory (DRAM)) that includes instructions that, when executed by the processing system 802, cause the processing system 802 to provide a microvisor engine 808 that is configured to perform the functionality of the microvisor engines, microvisor subsystems, and/or microvisors discussed below.

In the examples provided below, the microvisor engine 808 provides an LCS resource utilization tracking engine that is configured to perform the functionality of the LCS resource utilization tracking engines and/or LCS resource utilization tracking subsystems discussed below. As such, one of skill in the art in possession of the present disclosure will appreciate how the microvisor engine 808/LCS resource utilization tracking engine may be provided with an agent that is configured to interact with the resource management system 304 as described below. However, in other embodiments, the LCS resource utilization tracking functionality for the LCS provisioning subsystem 800 may be provided by a service processor that is included in or coupled to the BMS 802 (e.g., a service processor provided by a Baseboard Management Controller (BMC) device), virtualization hardware included in or coupled to the BMS 802, a Basic Input/Output System (BIOS) (e.g., via BIOS microcode) included in or coupled to the BMS 802, and/or using any hardware, firmware, and/or other components that one of skill in the art in possession of the present disclosure would recognize as enabling the LCS resource utilization tracking functionality described below.

In the illustrated embodiment, a plurality of resource devices 810 are coupled to the resource management subsystem 304 and the BMS 802, and may be provided by any of the resource devices 404a-404c in the resource systems 306a-306c/400 included in the LCS provisioning subsystem 300 discussed above with reference to FIGS. 3 and 4. As will be appreciated by one of skill in the art in possession of the present disclosure, the processing system 804 and the memory system 806 in the BMS 802 that are used to provide the microvisor engine 804 as discussed above may also be considered resource devices (i.e., in addition to the resource devices 810) that may be used to provide LCSs as described below. However, while a specific example of an LCS provisioning subsystem 800 is illustrated and described, one of skill in the art in possession of the present disclosure will appreciate how LCS provisioning subsystems provided according to the teachings of the present disclosure may include a variety of components and/or component configurations that will fall within the scope of the present disclosure as well.

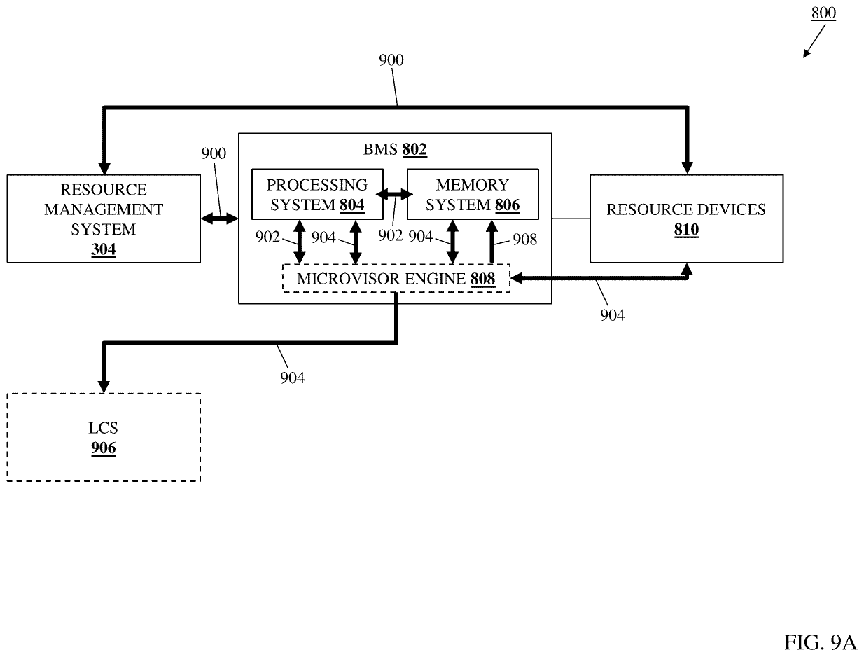

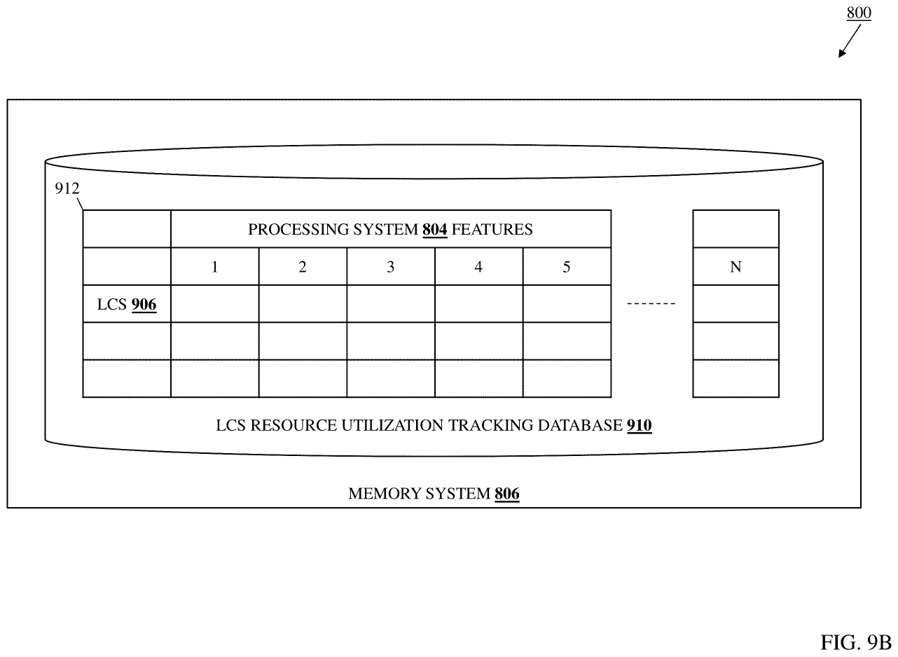

With reference to FIG. 9A, in an embodiment of block 702, the resource management system 304 may perform resource device configuration operations 900 that may include receiving a workload intent that was provided by a user as described above and, in response, configuring any (or any portion) of the processing system 804 in the BMS 802, the memory system 806 in the BMS 802, and the resource devices 810 to compose an LCS that satisfies that workload intent similarly as described above. Following the resource device configuration operations 900 by the resource management system 304, the processing system 804 may perform microvisor control operations 902 that include executing instructions on the memory system 806 to control the microvisor engine 808 to cause the microvisor engine 808 to perform LCS provisioning operations 904 that include providing an LCS 906 using any (or any portion) of the processing system 804 in the BMS 802, the memory system 806 in the BMS 802, and the resource devices 810 that were configured by the resource management system 304 as part of the resource device configuration operations 900.

Furthermore, in response to providing the LCS 906, the microvisor engine 808 may perform LCS/resource device counter activation operations 908 that may include activating at least one LCS/resource device counter in the memory system 806 for each resource device that is being utilized to provide the LCS 906. For example, with reference to FIG. 9B, an embodiment of an LCS resource utilization tracking database 910 in the memory system 806 is illustrated that includes a processing system feature tracking table 912 that provides for the tracking of the utilization of different features (identified as features 1, 2, 3, 4, 5, and up to N) provided by the processing system 804. For example, the LCS resource utilization tracking database 910 may be provided by a bitmap table, and while that bitmap table is described below as providing for the tracking of the utilization of a resource device by a plurality of LCSs, the use of a respective bitmap table to track the utilization of a resource device by each LCS will fall within the scope of the present disclosure as well. Furthermore, while a bitmap table is described, the use of other data structures to provide the tracking functionality discussed below will fall within the scope of the present disclosure as well.

As will be appreciated by one of skill in the art in possession of the present disclosure, specific examples of features provided by the processing system 804 may include any capabilities enables by the processing system via Advanced Vector eXtensions (AVX) such as a Single Hashing Algorithm (SHA) hashing capabilities, encryption capabilities, and/or other capabilities that would be apparent to one of skill in the art in possession of the present disclosure. Furthermore, while an example of processing system features has been provided, other functionality (e.g., Peripheral Component Interconnect (PCI) functions such as Network Interface Controller (NIC) PCI functions like those provided by a Remote Direct Memory Access (RDMA) NIC device with an Ethernet function and an RDMA function, accelerator devices, etc.) will fall within the scope of the present disclosure as well.

In the specific example illustrated in FIGS. 9A and 9B, the LCS/resource device counter activation operations 908 may include providing an identifier for the LCS 906 in a row of the processing system feature tracking table 912 to activate corresponding LCS/resource device counters for each feature 1-N provided by the processing system 804 in order to allow the utilization of any of those features 1-N by the LCS 906 to be tracked in the LCS resource utilization tracking database 910.

Furthermore, while a specific processing system feature tracking table 912 for tracking utilization of features provided by the processing system 804 has been illustrated and described, one of skill in the art in possession of the present disclosure will appreciate how LCS/resource device counters in a memory system feature tracking table for the memory system 806, as well as respective resource device feature tracking tables for each of the resource devices 810 being used to provide the LCS 906, may be activated in a similar manner at block 702 while remaining within the scope of the present disclosure as well. Furthermore, one of skill in the art in possession of the present disclosure will appreciate how the processing system feature tracking table 912 and similar resource device tracking tables may include integrated policy thresholds to allow for the identification of when, for example, utilization thresholds for processing system features or other resource devices have been exceeded, as well an actions to perform in such situations.

As such, the provisioning of the LCS 906 at block 702 may include activating respective LCS 906/resource device counters for each resource device and/or resource device feature that may be utilized by the LCS 906 during its operation. However, while the activation of counters in tables for use in tracking resource device utilization by the LCS 906 has been described, one of skill in the art in possession of the present disclosure will appreciate how the utilization by the LCS 906 of its resource devices may be tracked using other techniques that will fall within the scope of the present disclosure as well.

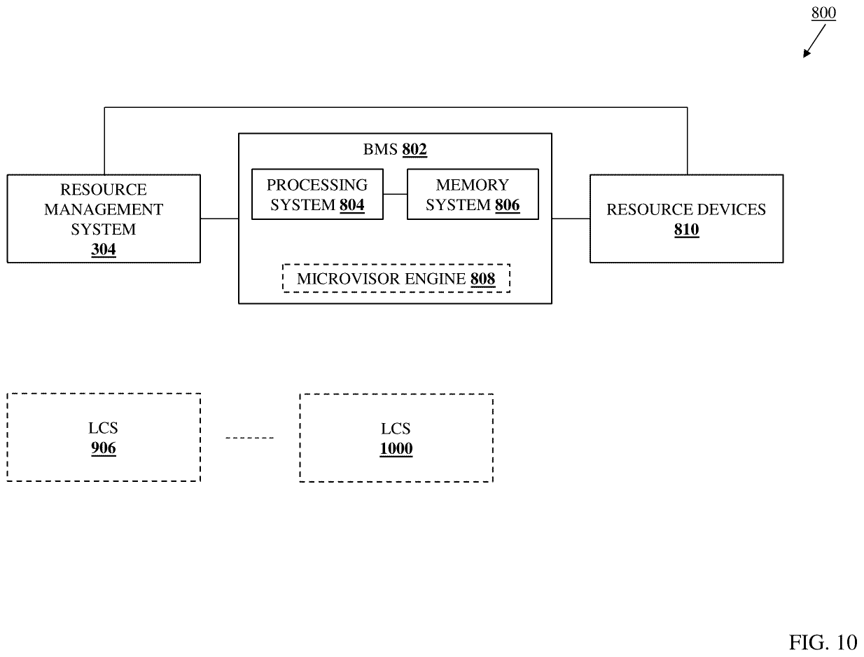

With reference to FIG. 10, in an embodiment of block 702, the resource management system 304 may provide a plurality of other LCSs up to an LCS 1000 similarly as described above for the LCS 906. As such, for each of those LCSs, the resource management system 304 may receive a workload intent that was provided by a user as described above and configure resource devices to compose that LCS that satisfies its corresponding workload intent similarly as described above, with a microvisor engine (e.g., which is similar to the microvisor engine 808 but which may be included in another BMS) providing that LCS and activating LCS/resource device counters for that LCS similarly as described above.

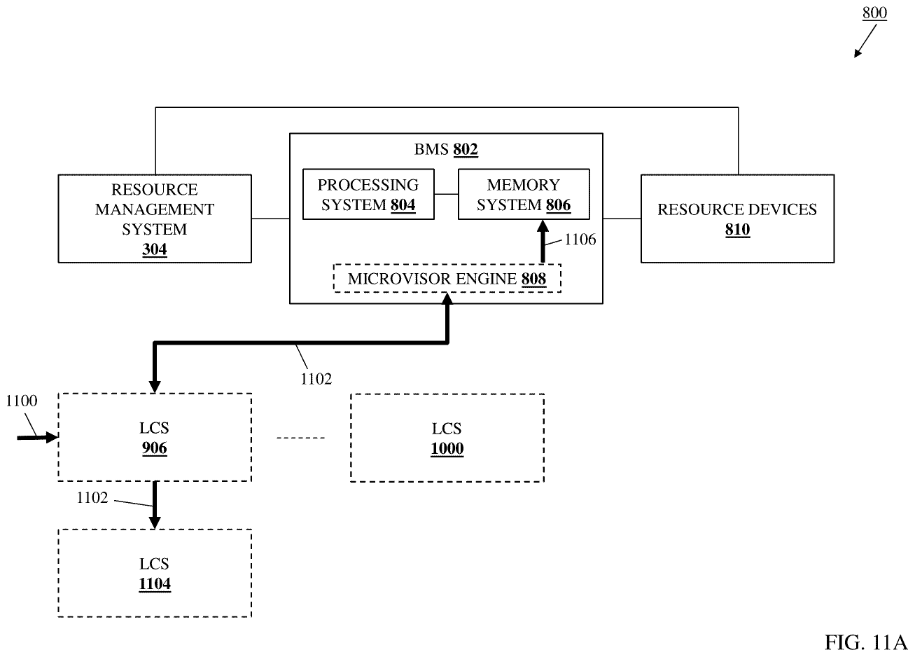

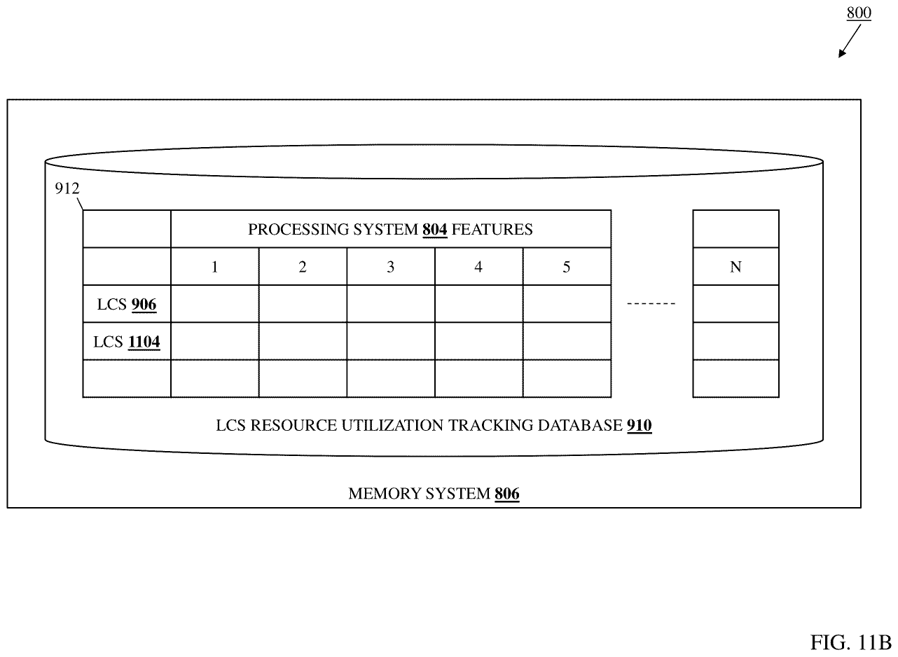

With reference to FIG. 11A, in an embodiment of block 702, the LCS 906 may perform workload intent receiving operations 1100 that may include receiving a workload intent from a user similarly as described above for the resource management system 304 and, in response, may perform nested LCS provisioning operations 1102 with the microvisor engine 808 that include configuring any (or any portion) of the processing system 804 in the BMS 802, the memory system 806 in the BMS 802, and the resource devices 810 that were used to compose the LCS 906 in order to provide an LCS 1104 that one of skill in the art in possession of the present disclosure will recognize provides an example of a “nested” LCS with regard to the LCS 906 (e.g. the LCS 906 may be provided using a first subset of cores in the processing system 804, and the LCS 1104 may be provided using a second subset of cores in the processing system 804).

As will be appreciated by one of skill in the art in possession of the present disclosure, in some embodiments the nested LCS provisioning operations 1102 may include the LCS 906 performing any of the functionality described above for the resource management system 304. However, in other embodiments, the nested LCS provisioning operations 1102 may include the LCS 906 communicating with the resource management system 304 to provide the LCS 1104, with the resource management system 304 performing at least some of the functionality described above. In a specific example, the LCS 906 may provide a hypervisor (e.g., a MICROSOFT® HYPERV® hypervisor, a LINUX® KVM hypervisor, a VMWARE hypervisor, etc.) or KUBERNETES® infrastructure-running Kata-style virtualization system that is controlled by the resource management system 304 to provide the nested LCS 1104.

Similarly as described above, in response to providing the LCS 1104, the microvisor engine 808 may perform LCS/resource device counter activation operations 1106 that may include activating at least one LCS/resource device counter in the memory system 806 for each resource device that is being utilized to provide the LCS 1104. For example, with reference to FIGS. 11A and 11B, the LCS/resource device counter activation operations 1106 may include providing an identifier for the LCS 1104 in a row of the processing system feature tracking table 912 to activate corresponding LCS/resource device counters for each feature 1-N provided by the processing system 804 in order to allow the utilization of any of those features 1-N by the LCS 1104 to be tracked in the LCS resource utilization tracking database 910.

As discussed above, while a specific processing system feature tracking table 912 for tracking utilization of features provided by the processing system 804 has been illustrated and described, one of skill in the art in possession of the present disclosure will appreciate how LCS/resource device counters in a memory system feature tracking table for the memory system 806 and respective resource device feature tracking tables for each of the resource devices 810 being used to provide the LCS 1104 may be activated in a similar manner at block 702 while remaining within the scope of the present disclosure as well. As such, the provisioning of the LCS 1104 at block 702 may include activating respective LCS 1104/resource device counters for each resource device and/or resource device feature that may be utilized by the LCS 1104 during its operation.

As will be appreciated by one of skill in the art in possession of the present disclosure, the utilization of the LCS provisioning subsystem 800 to provide LCS may be conceptualized as different levels of utilization of resources in the LCS provisioning subsystem 800, with the microvisor engine 808 performing Level 0 (L₀) utilization of the resources in the LCS provisioning subsystem 800, the LCS 906 and up to the LCS 1000 performing Level 1 (L₁) utilization of the resources in the LCS provisioning subsystem 800, and the LCS 1104 performing Level 2 (L₂) utilization of the resources in the LCS provisioning subsystem 800. In particular, for the specific example provided below, the microvisor engine 808 performs L₀ utilization of the processing system 804, the LCS 906 performs L₁ utilization of the processing system 804, and the LCS 1104 performs L₂ utilization of the processing system, but one of skill in the art in possession of the present disclosure will appreciate how the L₀, L₁, and/or L₂ utilizations discussed above may be performed for any resource in the LCS provisioning subsystem 800. As will be appreciated by one of skill in the art in possession of the present disclosure, it is desirable to distinguish between the L₁ and L₂ utilizations discussed above in order to allow for discrete billing of those utilizations, future resource device scheduling, and/or for other reasons that would be apparent to one of skill in the art in possession of the present disclosure.

Furthermore, in embodiments in which the service processor, virtualization hardware or BIOS discussed above is used to provide the LCS resource utilization tracking functionality for the LCS provisioning subsystem 800 in place of the microvisor engine 808, the service processor, virtualization hardware, or BIOS may perform Level −1 (L₋₁) utilization of the resources in the LCS provisioning subsystem 800. As will be appreciated by one of skill in the art in possession of the present disclosure, it may be desirable for such L₋₁ utilizations to distinguish between the L₀, L₁, and L₂ utilizations discussed above in order to allow for discrete billing of those utilizations. As will be appreciated by one of skill in the art in possession of the present disclosure, the performance of the LCS resource utilization tracking subsystem will be relatively higher when provided via the L₋₁ utilization of resources discussed above as compared to the L₀ utilization of resources discussed above, but implementation of the LCS resource utilization tracking subsystem will be relatively easier when provided via the L₀ utilization of resources discussed above, and thus implementations of the present disclosure may begin with the L₀ utilization of resources and may be transitioned to the L₋₁ utilization of resources over time.

The method 700 then proceeds to decision block 704 where the method 700 proceeds depending on whether an LCS utilization request for an LCS to utilize a resource device is received. As will be appreciated by one of skill in the art in possession of the present disclosure, during their provisioning, any of the LCSs 906-1000 and 1104 may utilize any of the resource devices that were used to compose them, and while the examples provided below describe the use of the processing system 804 in the BMS 802, one of skill in the art in possession of the present disclosure will appreciate how the utilization of any of the resources in the LCS provisioning subsystem 800 may be handled similarly as described below for the processing system 804. Thus, at decision block 704, the method 700 may proceed depending on whether any of the LCSs 906-1000 or 1104 request the utilization of a resource in the LCS provisioning subsystem 800.

If, at decision block 704, an LCS utilization request for an LCS to utilize a resource device is not received, the method 700 returns to decision block 704. As such, the method 700 may loop until an LCS utilization request for an LCS to utilize a resource device is received, and one of skill in the art in possession of the present disclosure will appreciate how the resource management system 304 may decompose LCSs that were provided at block 702, and compose LCSs similarly as described above at block 702, while monitoring for LCS utilization requests at decision block 704.

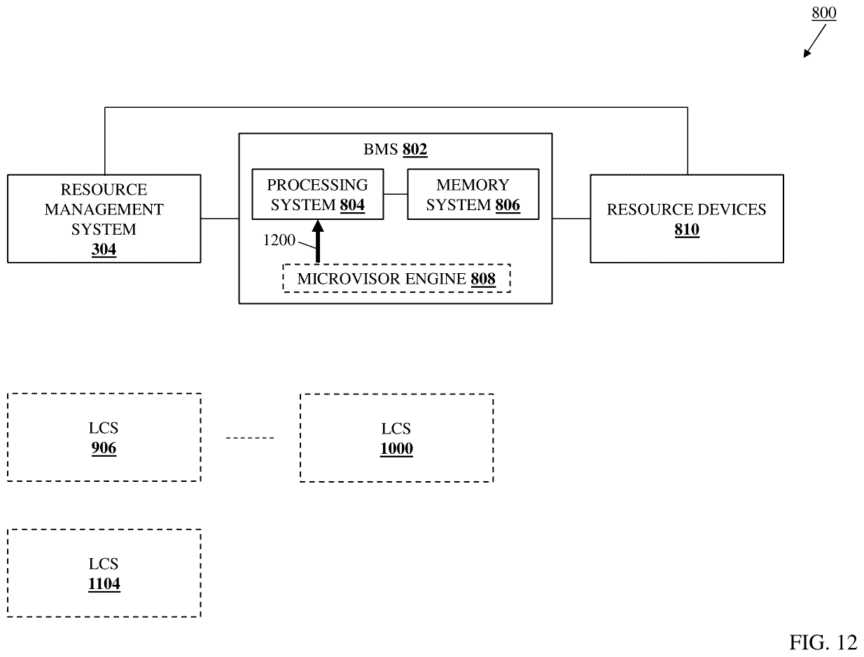

If, at decision block 704, an LCS utilization request for an LCS to utilize a resource device is received, the method 700 proceeds to block 706 where an LCS utilization tracking subsystem enables utilization of the resource device by the LCS. With reference to FIG. 12, following the provisioning of the LCS 906, the microvisor engine 808 may perform LCS utilization request notification configuration operations 1200 that include configuring the processing system 804 with an “exit trap” or other interrupt mechanism that will cause the processing system 804 to generate an interrupt to notify the microvisor engine 808 in response to receiving an LCS utilization request from the LCS 906. However, while the processing system is described as being configured to notify the microvisor engine 808 of an LCS utilization request by the LCS 906, one of skill in the art in possession of the present disclosure will appreciate how any of the memory system 806 and/or resource devices 810 may be configured in a similar manner while remaining within the scope of the present disclosure as well. Furthermore, while a specific technique for configuring resource devices to provide notifications in response to receiving requests for their utilization from LCSs has been described, one of skill in the art in possession of the present disclosure will appreciate that resource devices may be configured to provide notifications of their utilization using other techniques that will fall within the scope of the present disclosure as well.

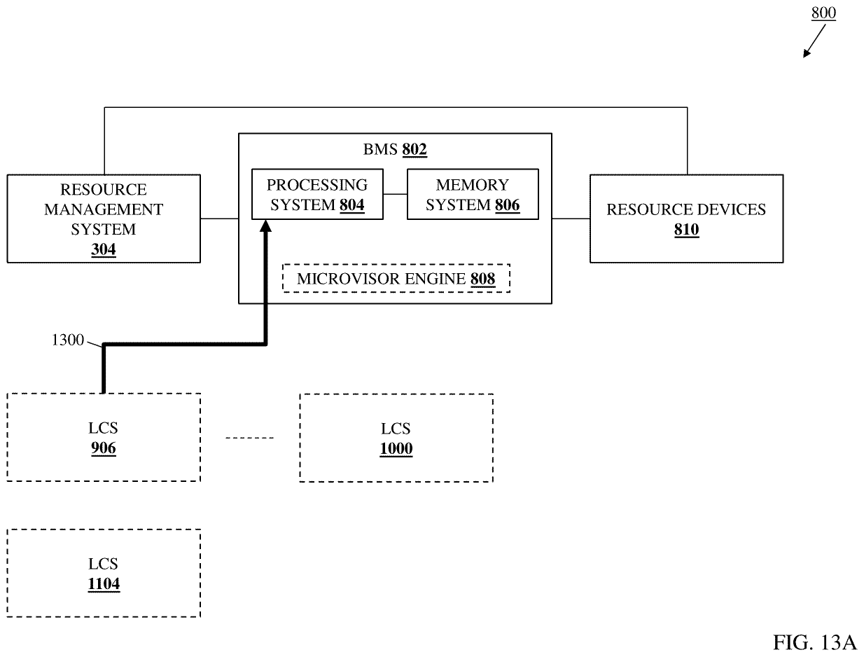

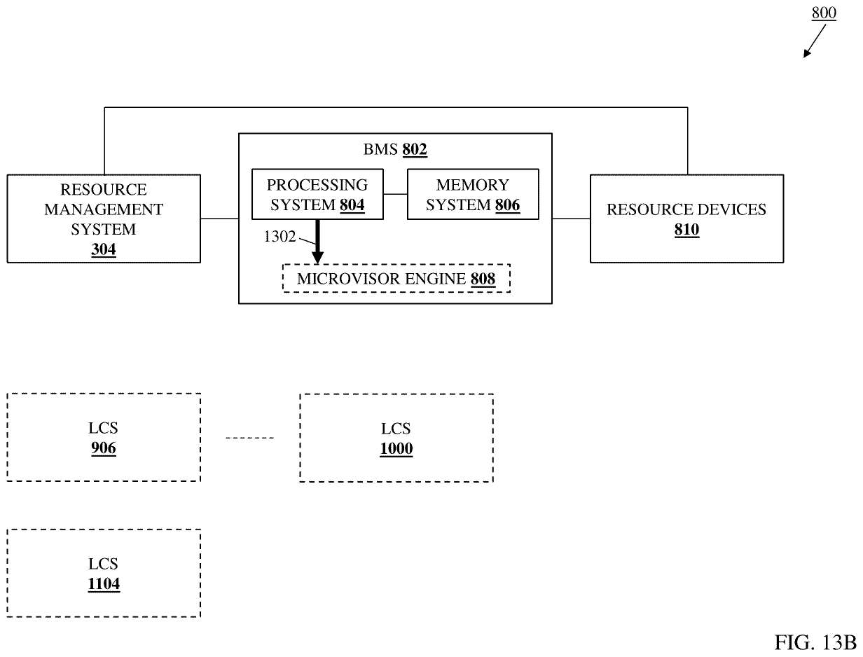

With reference to FIG. 13A, in an embodiment of decision block 704, the LCS 906 may perform LCS utilization request provisioning operations 1300 that include generating an LCS utilization request to utilize a feature of the processing system 804, and transmitting that LCS utilization request to the processing system 804 in the BMS 802. With reference to FIG. 13B, in response to receiving the LCS utilization request from the LCS 906, the processing system 804 may perform LCS utilization request notification operations 1302 that include generating an LCS utilization request notification that includes the LCS utilization request (e.g., based on the “exit trap” or other interrupt mechanism configured in the processing system 804 by the microvisor engine 808 as described above), and providing the LCS utilization request notification to the microvisor engine 808 such that it receives the LCS utilization request. However, while a specific technique for the microvisor engine 808 to receive the LCS utilization request generated by the LCS 906 has been described, one of skill in the art in possession of the present disclosure will appreciate how the microvisor engine 808 may receive LCS utilization requests in other manners that will fall within the scope of the present disclosure as well.

In an embodiment, at block 706 and in response to receiving the LCS utilization request, the microvisor engine 808 may identify the LCS 906 that generated the LCS utilization request (e.g., via an identifier for the LCS 906 that may be included in the LCS utilization request), identify any policies associated with the use of the processing system 804 by the LCS 906, and then authenticate the LCS utilization request by verifying that the feature of the processing system 804 requested to be utilized by the LCS 906 is allowed according to policies associated with the use of the processing system 804 by the LCS 906, polices associated with the LCS 906, and/or any other policies that would be apparent to one of skill in the art in possession of the present disclosure. However, while specific authentication operations have been described, one of skill in the art in possession of the present disclosure will appreciate how the microvisor engine 808 may authenticate the LCS utilization request using any authentication techniques that would be apparent to one of skill in the art in possession of the present disclosure.

In response to authenticating the LCS utilization request, the microvisor engine 808 may enable the utilization of the processing system 804 by the LCS 906 by instructing the processor to enable the feature of the processing system 804 for utilization by the LCS 906. In different embodiments, the enablement of the feature of the processing system 804 for utilization by the LCS 906 may include enabling a single use of the feature of the processing system 804 by the LCS 906, enabling some plurality of uses of the feature of the processing system 804 by the LCS 906, enabling use of the feature of the processing system 804 by the LCS 906 for a time period, and enabling the feature of the processing system 804 for use by the LCS 906 using other techniques that would be apparent to one of skill in the art in possession of the present disclosure.

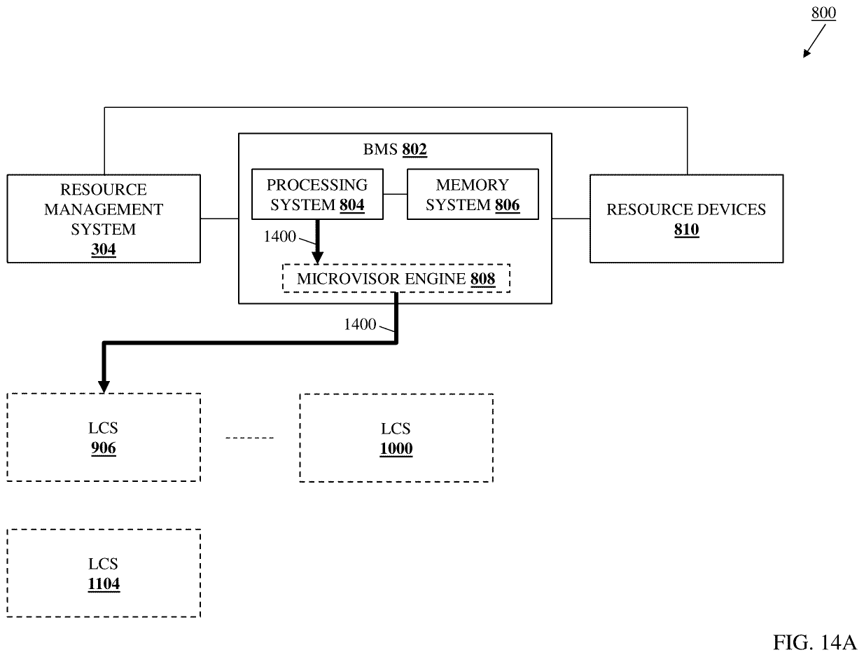

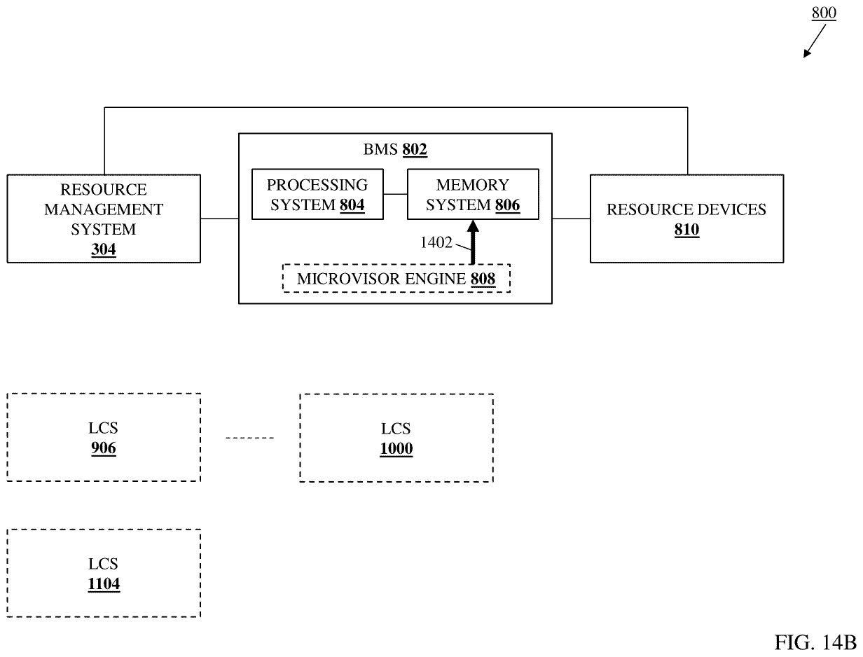

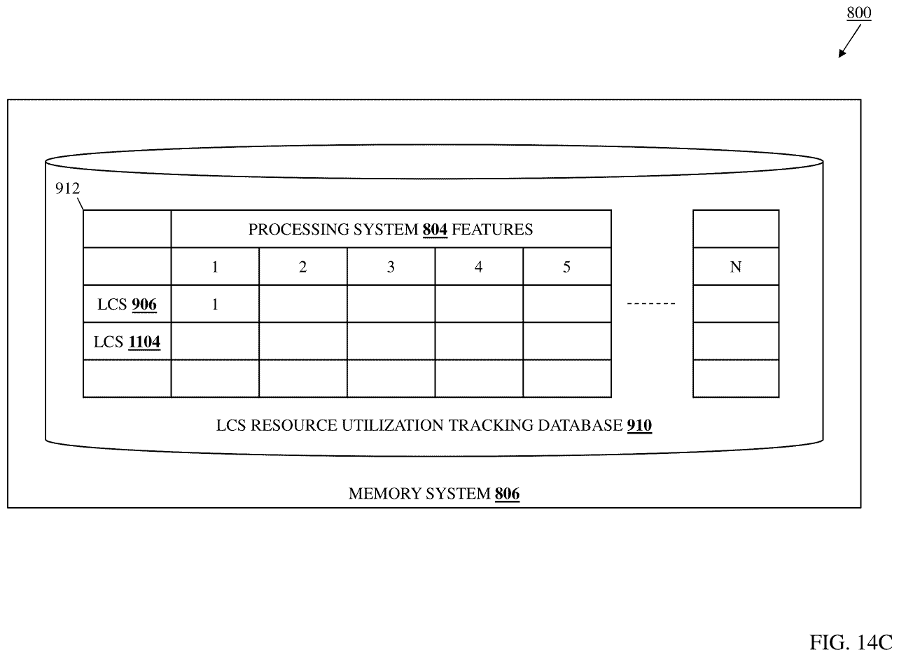

The method 700 then proceeds to block 708 where the LCS resource utilization tracking subsystem tracks the utilization of the resource device by the LCS. With reference to FIG. 14A, in response to enabling use of the feature of the processing system 804 that was requested for utilization by the LCS 906, the microvisor engine 808 may perform instruction execution operations 1400 that include executing an instruction based on the LCS utilization request using the processing system 804 in order to utilize the feature of the processing system 804 requested for utilization by the LCS 906, and providing the result of the execution of that instruction to the LCS 906. With reference to FIGS. 14B and 14C, in response the utilization of the feature of the processing system 804, the microvisor engine 808 may perform utilization tracking operations 1402 that include incrementing the LCS/resource device counter for the utilization of that feature of the processing system 804 by the LCS 906 (e.g., incrementing the LCS/resource device counter for the utilization of feature “1” of the processing system 804 by the LCS 906 to “1” in the illustrated example) in the processing system feature tracking table 912 included in the LCS resource utilization tracking database 910.

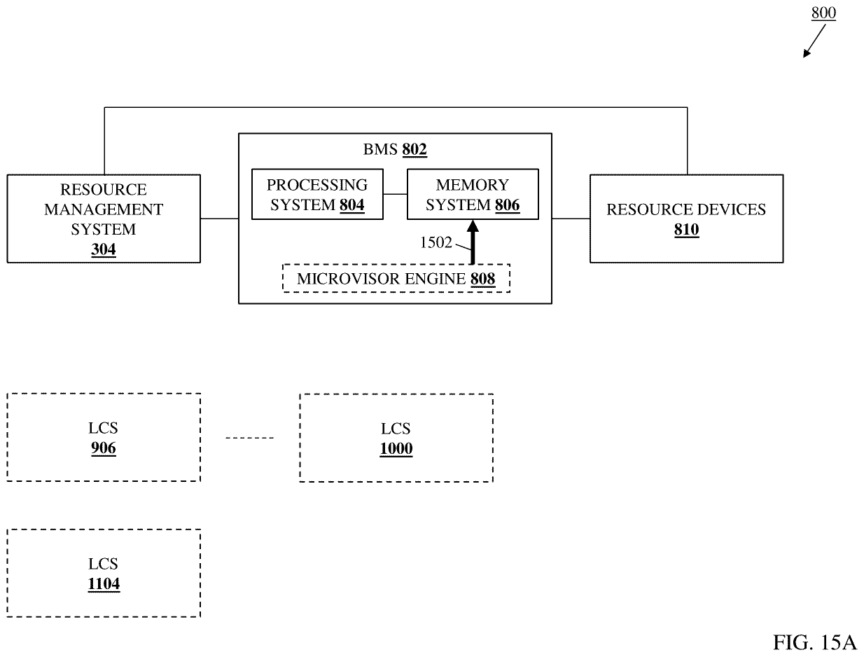

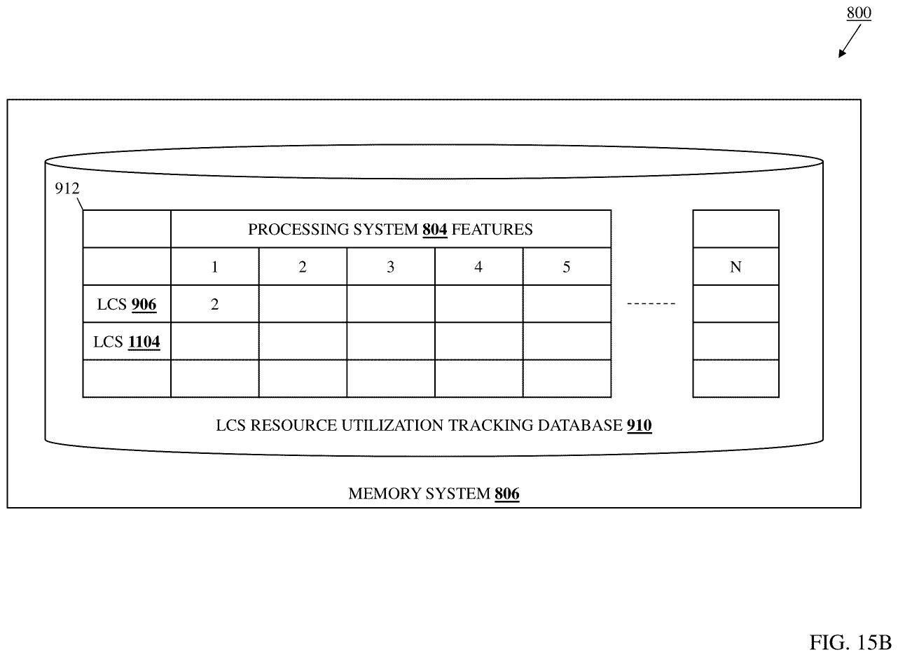

Furthermore, with reference to FIGS. 15A and 15B, a subsequent utilization of that feature of the processing system 804 by the LCS 906 may cause the microvisor engine 808 to perform utilization tracking operations 1502 that include incrementing the LCS/resource device counter for the utilization of that feature of the processing system 804 by the LCS 906 (e.g., incrementing the LCS/resource device counter for the utilization of feature “1” of the processing system 804 by the LCS 906 to “2” in the illustrated example) in the processing system feature tracking table 912 included in the LCS resource utilization tracking database 910, and one of skill in the art in possession of the present disclosure will appreciate the incrementing of the LCS/resource device counter for the utilization of that feature of the processing system 804 by the LCS 906 may be repeated for each “use” by the LCS 906.

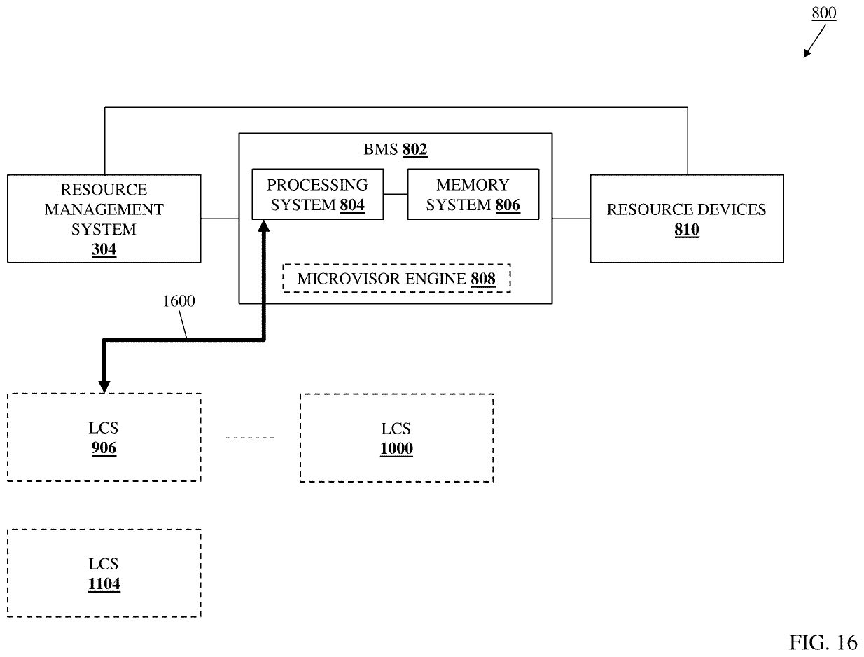

As will be appreciated by one of skill in the art in possession of the present disclosure, in embodiments in which a single use of the feature of the processing system 804 is enabled for utilization by the LCS 906, the tracking of each use of that feature of the processing system 804 by the LCS 906 may be performed similarly as described above (i.e., with the LCS 906 providing the LCS utilization request to the processing system 804, the processing system 804 notifying the microvisor engine 808, and the microvisor executing an instruction in the LCS utilization request and incrementing the LCS/resource device counter as described above). However, with reference to FIG. 16 and in embodiments in which a plurality of uses of the feature of the processing system 804 are enabled for utilization by the LCS 906, or the utilization of the feature of the processing system 804 is enabled by the LCS 906 for a time period, the LCS 906 may be configured to perform LCS instruction execution operations 1600 that include executing instructions using that feature of the processing system 804 for that plurality of times or during that time period (i.e., with the LCS/resource device counter incremented one time for each of those plurality of uses or each time period of use).

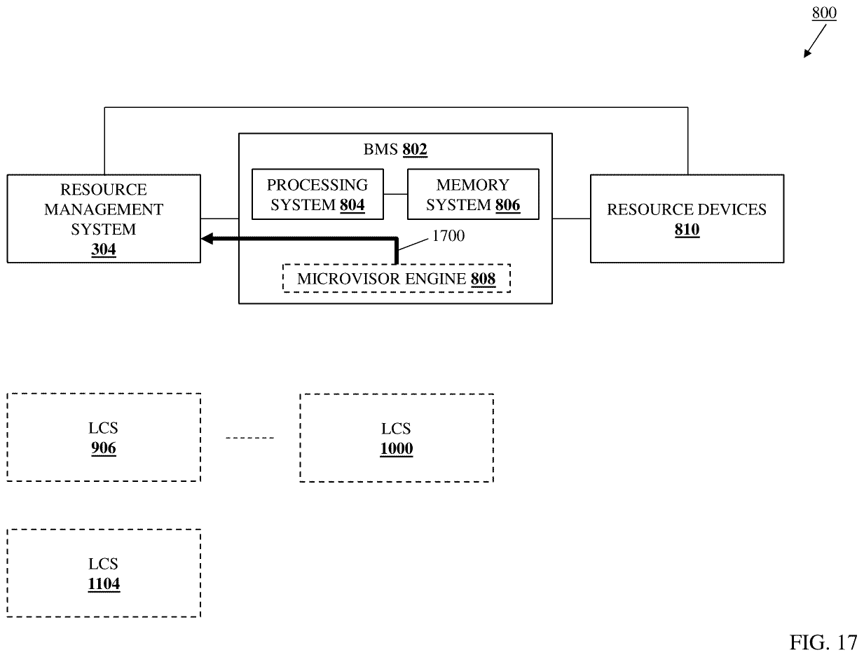

The method 700 then proceeds to block 710 where the LCS resource utilization tracking subsystem identifies to the resource management system utilization billing information for the utilization of the resource device by the LCS. With reference to FIG. 17, in an embodiment of block 710, the microvisor engine 808 may perform utilization billing information provisioning operations 1700 that include generating utilization billing information for the utilization of the feature of the processing system 804 by the LCS 906, and transmitting that utilization billing information to the resource management system 304, and one of skill in the art in possession of the present disclosure will appreciate how the resource management system 304 may cause that utilization billing information to be used to bill the user of the LCS 906 for its use of the processing system 804 using any of a variety of billing techniques that would be apparent to one of skill in the art in possession of the present disclosure. As will be appreciated by one of skill in the art in possession of the present disclosure, the utilization billing information generated by the microvisor engine 808 at block 710 may include the number of utilizations tracked in the LCS resource utilization tracking database 910, the number of utilizations tracked in the LCS resource utilization tracking database 910 multiplied by a utilization charge amount, and/or any other utilization billing information that would be apparent to one of skill in the art in possession of the present disclosure. Furthermore, one of skill in the art in possession of the present disclosure will recognize how the resource management system 304 may store and use utilization billing information for future resource device utilization projections while remaining within the scope of the present disclosure as well.

The method 700 may then return to decision block 704. As such, the method 700 may loop such that each utilization of a resource device by an LCS is enabled and tracked so that utilization billing information for that utilization may be identified to the resource management system. An example will now be provided of the utilization of the processing system 804 by the “nested” LCS 1104 provided by the LCS 906 during a second iteration of the method 700 that may follow the first iteration of the method 700 described above.

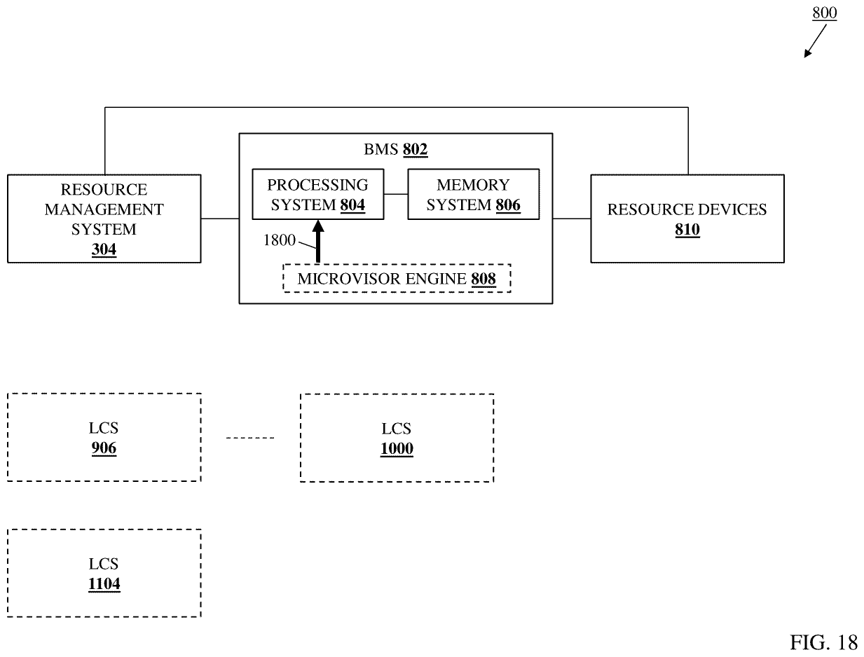

With reference to FIG. 18, following the provisioning of the LCS 906, the microvisor engine 808 may perform LCS utilization request notification configuration operations 1800 that include configuring the processing system 804 with an “exit trap” or other interrupt mechanism that will cause the processing system 804 to generate an interrupt to notify the microvisor engine 808 in response to receiving an LCS utilization request from the LCS 1104. Similarly as described above, while the processing system is described as being configured to notify the microvisor engine 808 of an LCS utilization request by the LCS 906, one of skill in the art in possession of the present disclosure will appreciate how any of the memory system 806 and/or resource devices 810 may be configured in a similar manner while remaining within the scope of the present disclosure as well. Furthermore, while a specific technique for configuring resource devices to provide notifications in response to receiving requests for their utilization from LCSs has been described, one of skill in the art in possession of the present disclosure will appreciate that resource devices may be configured to provide notifications of their utilization using other techniques that will fall within the scope of the present disclosure as well.

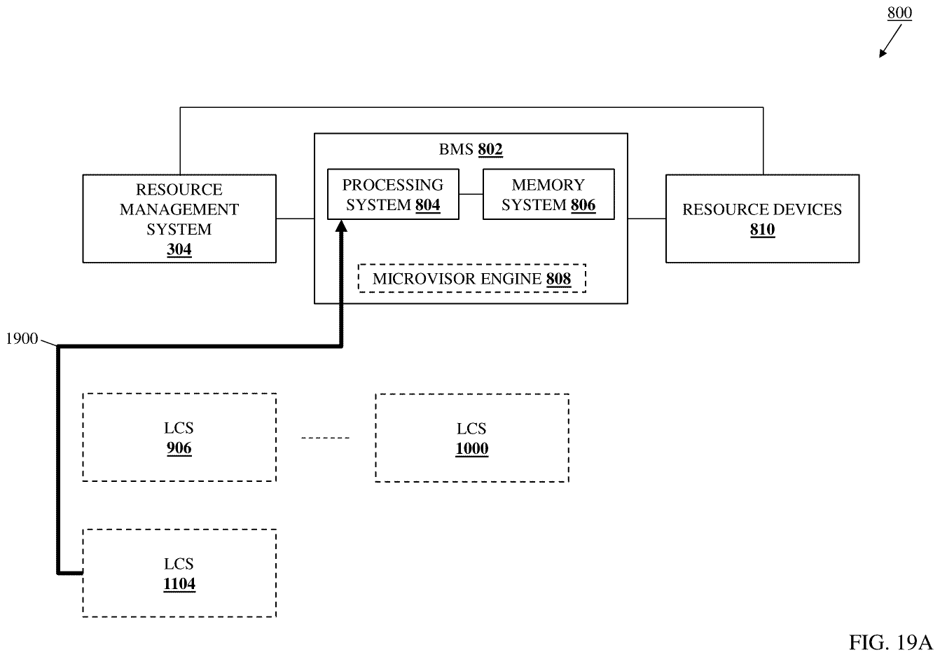

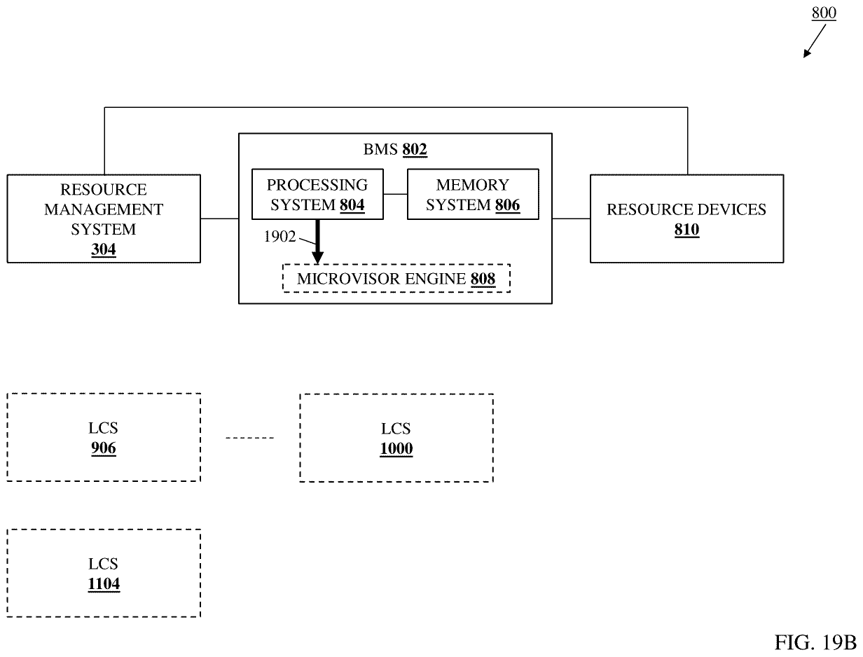

With reference to FIG. 19A, in an embodiment of decision block 704, the LCS 906 may perform LCS utilization request provisioning operations 1900 that include generating an LCS utilization request to utilize a feature of the processing system 804, and transmitting that LCS utilization request to the processing system 804 in the BMS 802. With reference to FIG. 19B, in response to receiving the LCS utilization request from the LCS 1104, the processing system 804 may perform LCS utilization request notification operations 1902 that include generating an LCS utilization request notification that includes the LCS utilization request (e.g., based on the “exit trap” or other interrupt mechanism configured in the processing system 804 by the microvisor engine 808 as described above), and providing the LCS utilization request notification to the microvisor engine 808 such that it receives the LCS utilization request. However, while a specific technique for the microvisor engine 808 to receive the LCS utilization request generated by the LCS 1104 has been described, one of skill in the art in possession of the present disclosure will appreciate how the microvisor engine 808 may receive LCS utilization requests in other manners that will fall within the scope of the present disclosure as well.

In an embodiment, at block 706 and in response to receiving the LCS utilization request, the microvisor engine 808 may identify the LCS 1104 that generated the LCS utilization request (e.g., via an identifier for the LCS 1104 that may be included in the LCS utilization request), identify any policies associated with the use of the processing system 804 by the LCS 1104, and then authenticate the LCS utilization request by verifying that the feature of the processing system 804 requested to be utilized by the LCS is allowed according to the policies associated with the use of the processing system 804 by the LCS 1104, policies associated with the use of the LCS 1104, and/or other policies that would be apparent to one of skill in the art in possession of the present disclosure. However, while specific authentication operations have been described, one of skill in the art in possession of the present disclosure will appreciate how the microvisor engine 808 may authenticate the LCS utilization request using any authentication techniques that would be apparent to one of skill in the art in possession of the present disclosure.

In response to authenticating the LCS utilization request, the microvisor engine 808 may enable the utilization of the processing system 804 by the LCS 1104 by instructing the processor to enable the feature of the processing system 804 for utilization by the LCS 1104. In different embodiments, the enablement of the feature of the processing system 804 requested for utilization by the LCS 1104 may include enabling a single use of the feature of the processing system 804 by the LCS 1104, enabling some plurality of uses of the feature of the processing system 804 by the LCS 1104, enabling use of the feature of the processing system 804 by the LCS 1104 for a time period, and enabling the feature of the processing system 804 using other techniques that would be apparent to one of skill in the art in possession of the present disclosure.

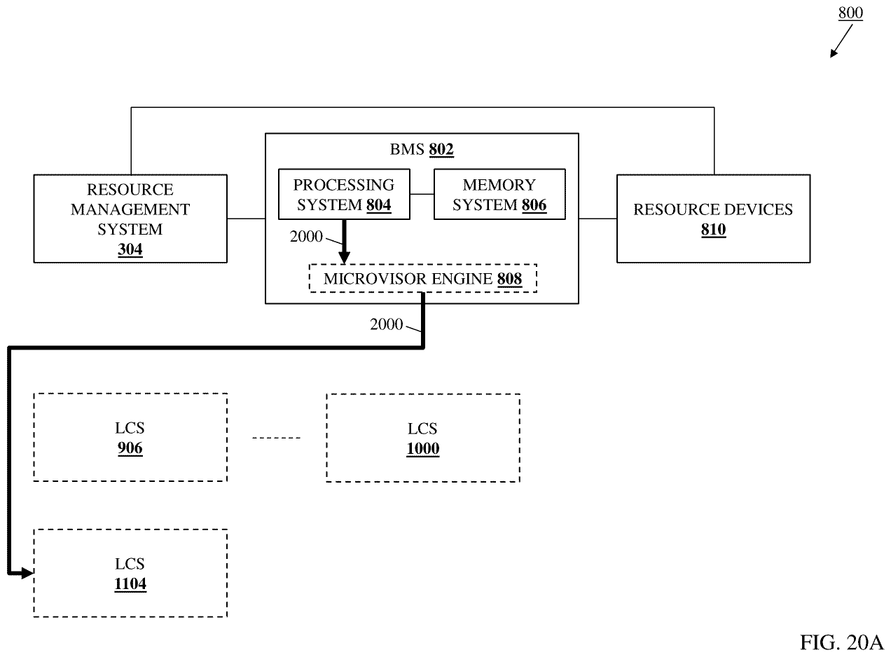

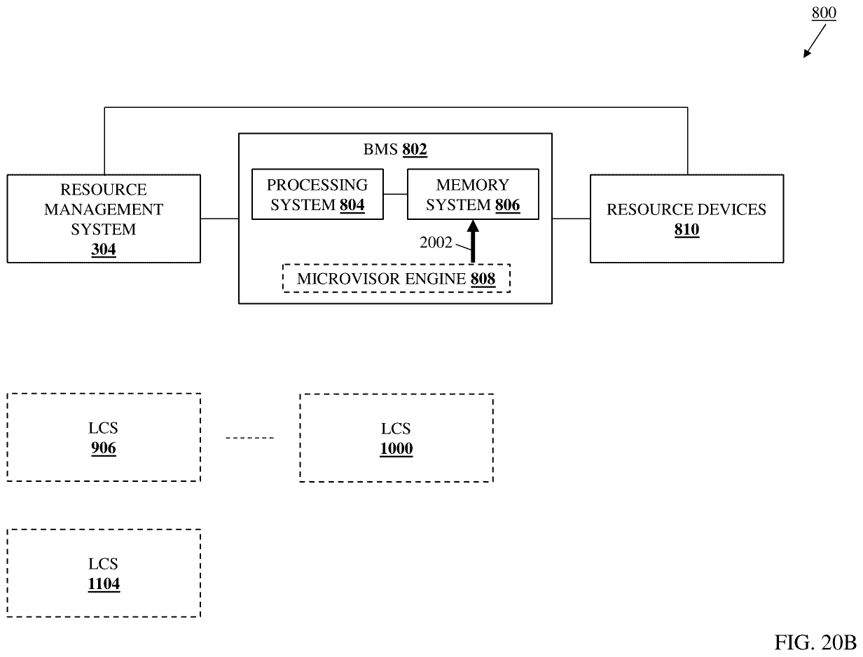

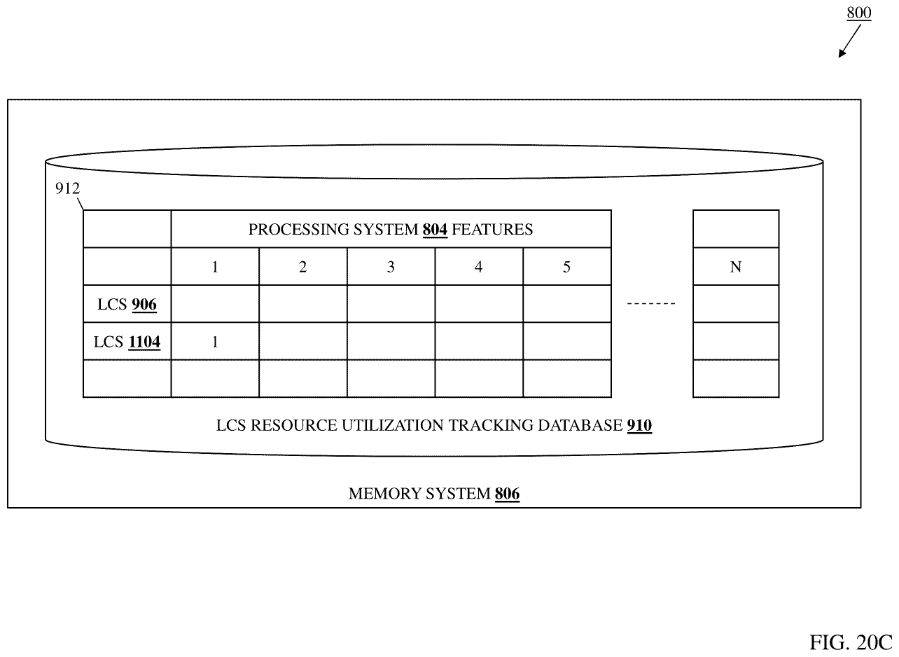

The method 700 then proceeds to block 708 where the LCS resource utilization tracking subsystem tracks the utilization of the resource device by the LCS. With reference to FIG. 20A, in response to enabling use of the feature of the processing system 804 that was requested for utilization by the LCS 1104, the microvisor engine 808 may perform instruction execution operations 2000 that include executing an instruction based on the LCS utilization request using the processing system 804 in order to utilize the feature of the processing system 804 requested for utilization by the LCS 1104, and providing the result of the execution of that instruction to the LCS 1104. With reference to FIGS. 20B and 20C, in response the utilization of the feature of the processing system 804, the microvisor engine 808 may perform utilization tracking operations 2002 that include incrementing the LCS/resource device counter for the utilization of that feature of the processing system 804 by the LCS 1104 (e.g., incrementing the LCS/resource device counter for the utilization of feature “1” of the processing system 804 by the LCS 1104 to “1” in the illustrated example) in the processing system feature tracking table 912 included in the LCS resource utilization tracking database 910.

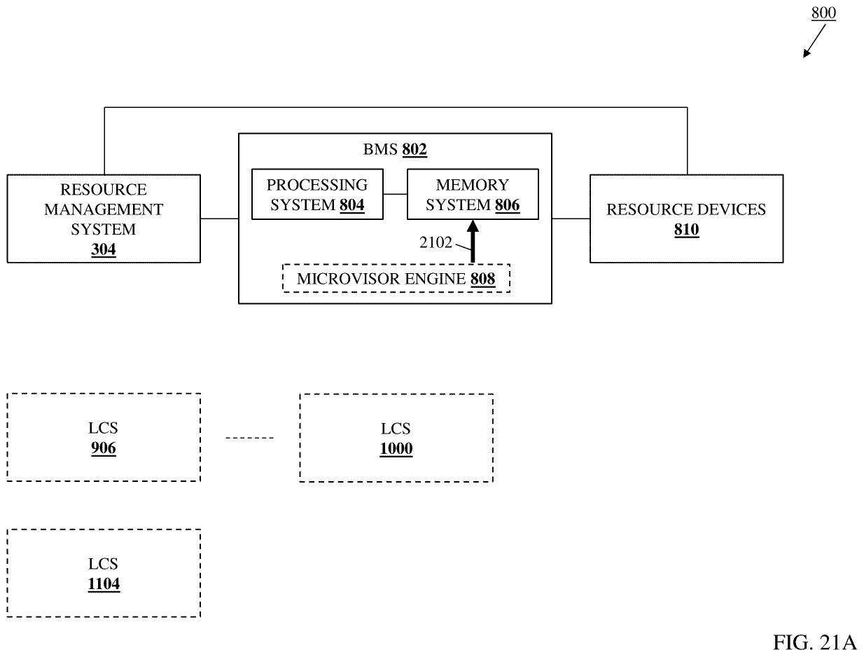

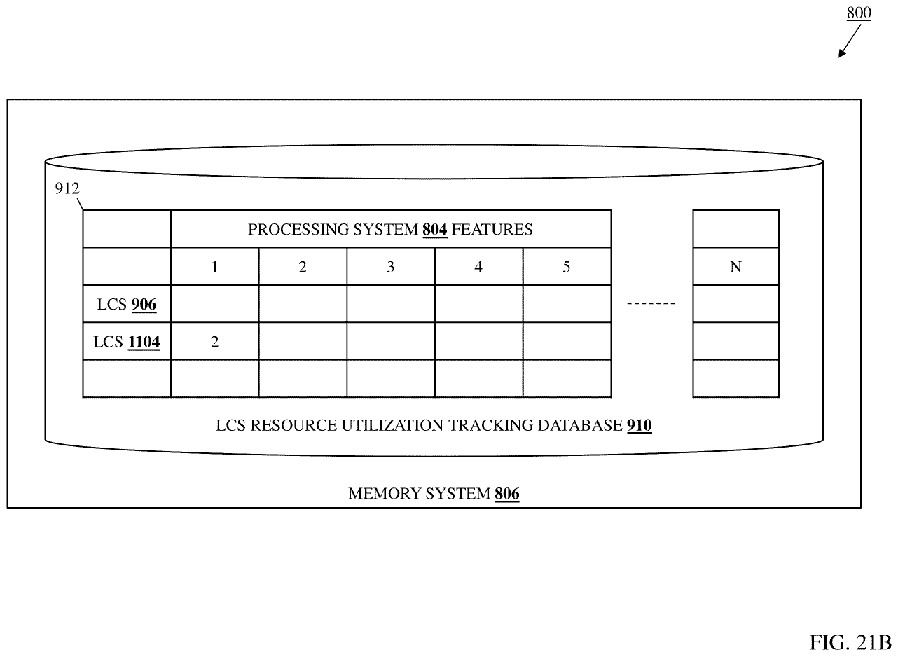

Furthermore, with reference to FIGS. 21A and 21B, a subsequent utilization of that feature of the processing system 804 by the LCS 906 may cause the microvisor engine 808 to perform utilization tracking operations 2102 that include incrementing the LCS/resource device counter for the utilization of that feature of the processing system 804 by the LCS 1104 (e.g., incrementing the LCS/resource device counter for the utilization of feature “1” of the processing system 804 by the LCS 1104 to “2” in the illustrated example) in the processing system feature tracking table 912 included in the LCS resource utilization tracking database 910.

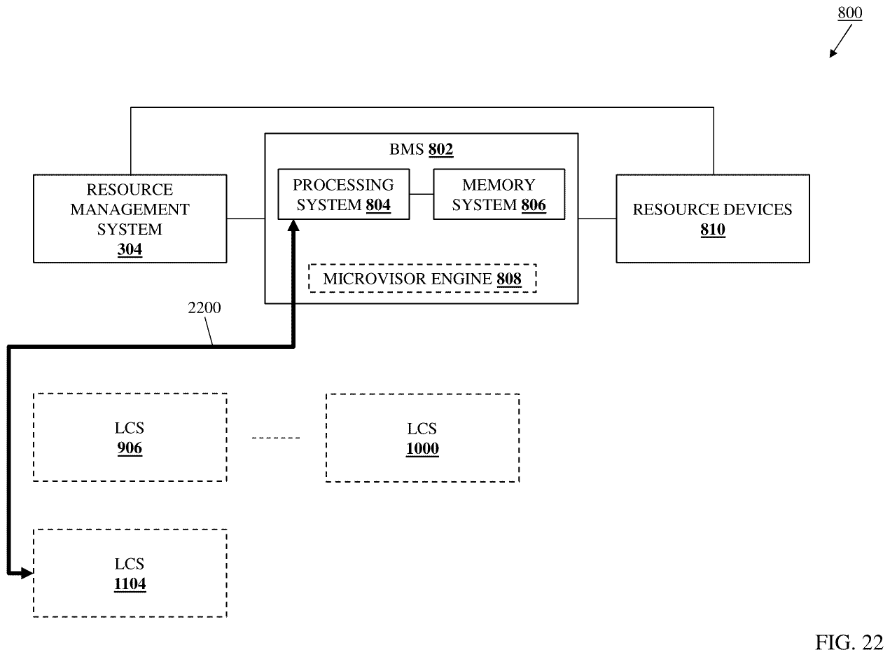

As will be appreciated by one of skill in the art in possession of the present disclosure, in embodiments in which a single use of the feature of the processing system 804 is enabled for utilization by the LCS 1104, the tracking of each use of that feature of the processing system 804 by the LCS 1104 may be performed similarly as described above (i.e., with the LCS 1104 providing the LCS utilization request to the processing system 804, the processing system 804 notifying the microvisor engine 808, and the microvisor executing an instruction in the LCS utilization request and incrementing the LCS/resource device counter as described above). However, with reference to FIG. 22 and in embodiments in which a plurality of uses of the feature of the processing system 804 are enabled for utilization by the LCS 1104, or the utilization of the feature of the processing system 804 is enabled by the LCS 1104 for a time period, the LCS 906 may be configured to perform LCS instruction execution operations 2200 that include executing instructions using the feature of the processing system 804 for that plurality of times or during that time period (i.e., with the LCS/resource device counter incremented one time for each of those plurality of uses or each time period of use).

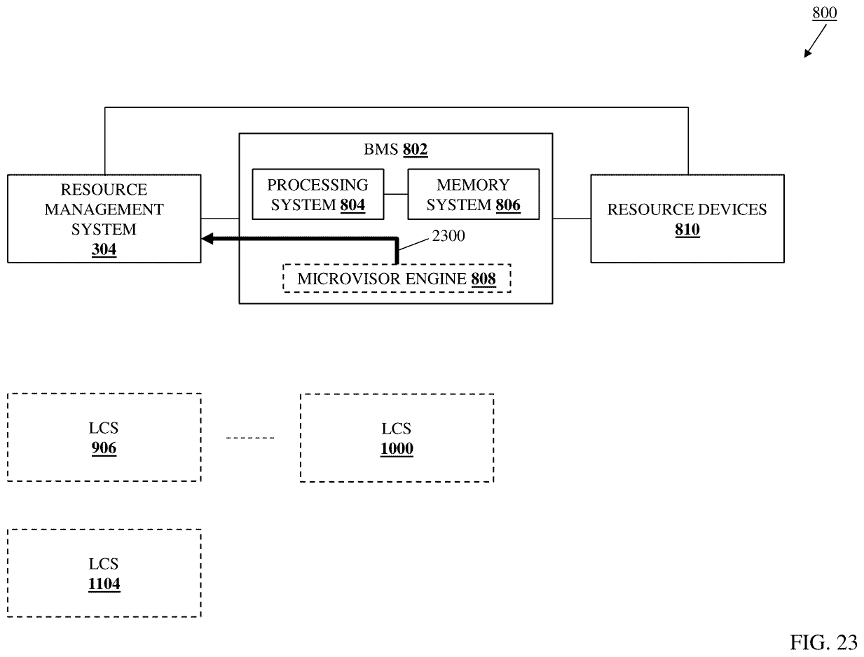

The method 700 then proceeds to block 710 where the LCS resource utilization tracking subsystem identifies to the resource management system utilization billing information for the utilization of the resource device by the LCS. With reference to FIG. 23, in an embodiment of block 710, the microvisor engine 808 may perform utilization billing information provisioning operations 2300 that include generating utilization billing information for the utilization of the feature of the processing system 804 by the LCS 1104, and transmitting that utilization billing information to the resource management system 304, and one of skill in the art in possession of the present disclosure will appreciate how the resource management system 304 may cause that utilization billing information to be used to bill the user of the LCS 1104 for its use of the processing system 804. As will be appreciate by one of skill in the art in possession of the present disclosure, the utilization billing information generated by the microvisor engine 808 at block 710 may include the number of utilizations tracked in the LCS resource utilization tracking database 910, the number of utilizations tracked in the LCS resource utilization tracking database 910 multiplied by a utilization charge amount, and/or any other utilization billing information that would be apparent to one of skill in the art in possession of the present disclosure. Furthermore, one of skill in the art in possession of the present disclosure will recognize how the resource management system 304 may store and use utilization billing information for future resource device utilization projections while remaining within the scope of the present disclosure as well.

As will be appreciated by one of skill in the art in possession of the present disclosure, the examples above have the microvisor engine 808 provided by the L₀ utilization of resources distinguish the L₁ utilization of resources by the LCS 906 and L₂ utilization of resources by the “nested” LCS 1104 provided by the LCS 906. However, one of skill in the art in possession of the present disclosure will appreciate how the LCSs 906 and 1104 are provided both via their respective L₁ utilization and L₂ utilization of resources, as well as the L₀ utilization of resources by the microvisor engine 808, and one of skill in the art in possession of the present disclosure will recognize how the teachings above may be extended to allow the service processor, virtualization hardware, or BIOS discussed above that are provided by the L₋₁ utilization of resources to distinguish the L₀ and L₁ utilization of resources that provide the LCS 906 via the microvisor engine 808, and the L₀ and L₂ utilization of resources that provide the LCS 1104 via the microvisor engine 808. As such, one of skill in the art in possession of the present disclosure will appreciate how the use of the L₋₁ utilization of resources to provide the LCS resource utilization tracking subsystem of the present disclosure enables the possibility of a Microvisor-as-a-Service (MaaS) billing model that bills users to enable their microvisors.

Thus, systems and methods have been described that provide for the tracking of the utilizations of a resource device by different LCSs in order to allow respective billing utilization information for each of those utilizations to be identified. For example, the LCS resource utilization tracking system of the present disclosure may include resource devices, a resource management system that composes first and second LCSs using a first resource device, and an LCS resource utilization tracking subsystem coupled to the resource devices and the resource management system. The LCS resource utilization tracking subsystem receives a first request for the first LCS to utilize the first resource device and, in response, enables and tracks the utilization of the first resource device by the first LCS and identifies first utilization billing information based on that tracked utilization to the resource management system. The LCS resource utilization tracking subsystem receives a second request for the second LCS to utilize the first resource device and, in response, enables and tracks the utilization of the first resource device by the second LCS and identifies second utilization billing information based on that tracked utilization of to the resource management system. As will be appreciated by one of skill in the art in possession of the present disclosure, the systems and methods of the present disclosure improve on conventional Silicon-as-a-Service (Si-aaS) systems, which simply bill users when processors are enabled for use, by enabling granular charges for different features that are available in processors and that are used by a tenant, enabling the ability to sell/charge for the utilization of subsets of processors rather than requiring tenants pay for an entire processor/all of the features available from a processor when many features are not needed.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Logically Composed System (LCS) resource utilization tracking system, comprising:
a plurality of resource devices;
a resource management system that is configured to compose a first Logically Composed System (LCS) and a second LCS using a first resource device included in the plurality of resource devices; and
an LCS resource utilization tracking subsystem that is coupled to the plurality of resource devices and the resource management system, wherein the LCS resource utilization tracking subsystem is configured to:
receive a first LCS utilization request for the first LCS to utilize the first resource device;
enable and track, in response to the first LCS utilization request, the utilization of the first resource device by the first LCS;
identify, to the resource management system based on the tracking of the utilization of the first resource device by the first LCS, first utilization billing information for the utilization of the first resource device by the first LCS;
receive a second LCS utilization request for the second LCS to utilize the first resource device;
enable and track, in response to the second LCS utilization request, the utilization of the first resource device by the second LCS; and
identify, to the resource management system based on the tracking of the utilization of the first resource device by the second LCS, second utilization billing information for the utilization of the first resource device by the second LCS.

2. The system of claim 1, wherein the tracking of the utilization of the first resource device by the first LCS and the utilization of the first resource device by the second LCS includes:
activating a first LCS/first resource device counter;
incrementing the first LCS/first resource device counter for at least one use of the first resource device by the first LCS, wherein the first utilization billing information is based on the incremented first LCS/first resource device counter;
activating a second LCS/first resource device counter; and
incrementing the second LCS/first resource device counter for at least one use of the first resource device by the second LCS, wherein the second utilization billing information is based on the incremented second LCS/first resource device counter.

3. The system of claim 1, wherein the LCS resource utilization tracking subsystem is configured to:
authenticate the first LCS utilization request prior to enabling the utilization of the first resource device by the first LCS; and
authenticate the second LCS utilization request prior to enabling the utilization of the first resource device by the second LCS.

4. The system of claim 1, wherein the LCS resource utilization tracking subsystem is configured to:
receive the first LCS utilization request from the first resource device;
enable, in response to the first LCS utilization request, the utilization of the first resource device by the first LCS for a first time period; and
execute a first instruction with the first resource device that is based on the first LCS utilization request to provide for a first subset of the utilization of the first resource device by the first LCS, wherein the first LCS is configured to execute at least one second instruction with the first resource device during the first time period to provide for a second subset of the utilization of the first resource device by the first LCS.

5. The system of claim 1, wherein the LCS resource utilization tracking subsystem is provided by a microvisor subsystem.

6. The system of claim 1, wherein the first resource device is provided by a processing system.

7. An Information Handling System (IHS), comprising:
a processing system; and
a memory system that is coupled to the processing system and that includes instructions that, when executed by the processing system, cause the processing system to provide a Logically Composed System (LCS) resource utilization tracking engine that is configured to:
receive a first LCS utilization request for a first LCS to utilize a first resource device;
enable and track, in response to the first LCS utilization request, the utilization of the first resource device by the first LCS;
identify, to a resource management system based on the tracking of the utilization of the first resource device by the first LCS, first utilization billing information for the utilization of the first resource device by the first LCS;
receive a second LCS utilization request for the second LCS to utilize the first resource device;
enable and track, in response to the second LCS utilization request, the utilization of the first resource device by the second LCS; and
identify, to the resource management system based on the tracking of the utilization of the first resource device by the second LCS, second utilization billing information for the utilization of the first resource device by the second LCS.

8. The IHS of claim 7, wherein the tracking of the utilization of the first resource device by the first LCS and the utilization of the first resource device by the second LCS includes:
activating a first LCS/first resource device counter;
incrementing the first LCS/first resource device counter for at least one use of the first resource device by the first LCS, wherein the first utilization billing information is based on the incremented first LCS/first resource device counter;
activating a second LCS/first resource device counter; and
incrementing the second LCS/first resource device counter for at least one use of the first resource device by the second LCS, wherein the second utilization billing information is based on the incremented second LCS/first resource device counter.

9. The IHS of claim 7, wherein the LCS resource utilization tracking engine is configured to:
authenticate the first LCS utilization request prior to enabling the utilization of the first resource device by the first LCS; and
authenticate the second LCS utilization request prior to enabling the utilization of the first resource device by the second LCS.

10. The IHS of claim 7, wherein the LCS resource utilization tracking engine is configured to:
receive the first LCS utilization request from the first resource device;
enable, in response to the first LCS utilization request, the utilization of the first resource device by the first LCS for a first time period; and
execute a first instruction with the first resource device that is based on the first LCS utilization request to provide for a first subset of the utilization of the first resource device by the first LCS, wherein the first LCS is configured to execute at least one second instruction with the first resource device during the first time period to provide for a second subset of the utilization of the first resource device by the first LCS.

11. The IHS of claim 7, wherein the LCS resource utilization tracking engine is configured to:
receive the second LCS utilization request from the first resource device;
enable, in response to the second LCS utilization request, the utilization of the first resource device by the second LCS for a first time period; and
execute a first instruction with the first resource device that is based on the second LCS utilization request to provide for a first subset of the utilization of the first resource device by the second LCS, wherein the second LCS is configured to execute at least one second instruction with the first resource device during the first time period to provide for a second subset of the utilization of the first resource device by the second LCS.

12. The IHS of claim 7, wherein the memory system includes instructions that, when executed by the processing system, cause the processing system to provide a microvisor subsystem that includes the LCS resource utilization tracking engine.

13. The IHS of claim 12, wherein the first resource device is provided by the processing system.

14. A method for tracking the utilization of resources by a Logically Composed System (LCS) comprising:
receiving, by a Logically Composed System (LCS) resource utilization tracking subsystem, a first LCS utilization request for a first LCS to utilize a first resource device;
enabling and tracking, by the LCS resource utilization tracking subsystem in response to the first LCS utilization request, the utilization of the first resource device by the first LCS;
identifying, by the LCS resource utilization tracking subsystem to a resource management system based on the tracking of the utilization of the first resource device by the first LCS, first utilization billing information for the utilization of the first resource device by the first LCS;
receiving, by the LCS resource utilization tracking subsystem, a second LCS utilization request for the second LCS to utilize the first resource device;
enabling and tracking, by the LCS resource utilization tracking subsystem in response to the second LCS utilization request, the utilization of the first resource device by the second LCS; and
identifying, by the LCS resource utilization tracking subsystem to the resource management system based on the tracking of the utilization of the first resource device by the second LCS, second utilization billing information for the utilization of the first resource device by the second LCS.

15. The method of claim 14, wherein the tracking of the utilization of the first resource device by the first LCS and the utilization of the first resource device by the second LCS includes:
activating a first LCS/first resource device counter;
incrementing the first LCS/first resource device counter for at least one use of the first resource device by the first LCS, wherein the first utilization billing information is based on the incremented first LCS/first resource device counter;
activating a second LCS/first resource device counter; and
incrementing the second LCS/first resource device counter for at least one use of the first resource device by the second LCS, wherein the second utilization billing information is based on the incremented second LCS/first resource device counter.

16. The method of claim 14, further comprising:
authenticating, by the LCS resource utilization tracking subsystem, the first LCS utilization request prior to enabling the utilization of the first resource device by the first LCS; and
authenticating, by the LCS resource utilization tracking subsystem, the second LCS utilization request prior to enabling the utilization of the first resource device by the second LCS.

17. The method of claim 14, further comprising:
receiving, by the LCS resource utilization tracking subsystem, the first LCS utilization request from the first resource device;
enabling, by the LCS resource utilization tracking subsystem in response to the first LCS utilization request, the utilization of the first resource device by the first LCS for a first time period; and
executing, by the LCS resource utilization tracking subsystem, a first instruction with the first resource device that is based on the first LCS utilization request to provide for a first subset of the utilization of the first resource device by the first LCS; wherein the first LCS is configured to execute at least one second instruction with the first resource device during the first time period to provide for a second subset of the utilization of the first resource device by the first LCS.

18. The method of claim 14, further comprising:
receiving, by the LCS resource utilization tracking subsystem, the second LCS utilization request from the first resource device;
enabling, by the LCS resource utilization tracking subsystem in response to the second LCS utilization request, the utilization of the first resource device by the second LCS for a first time period; and
executing, by the LCS resource utilization tracking subsystem, a first instruction with the first resource device that is based on the second LCS utilization request to provide for a first subset of the utilization of the first resource device by the second LCS, wherein the second LCS is configured to execute at least one second instruction with the first resource device during the first time period to provide for a second subset of the utilization of the first resource device by the second LCS.

19. The method of claim 14, wherein the LCS resource utilization tracking subsystem is provided by a microvisor subsystem.

20. The method of claim 14, wherein the first resource device is provided by a processing system.
